(19) United States
(12) Patent Application Publication
(10) Pub. No.: US 2007/0112616 A1
(43) Pub. Date: May 17, 2007

(54) Allocation requirements system and methodology

(76) Inventors: Dmitry Shubov, San Francisco, CA (US); Kenneth LaMance, San Francisco, CA (US); Neil Fradkin, San Francisco, CA (US)

Correspondence Address: Dergosits & Noah LLP, Suite 1450, Four Embarcadero Center, San Francisco, CA, 94111, US

(21) Appl. No.: 11/504,566

(22) Filed: Aug. 14, 2006

Related U.S. Application Data
(60) Provisional application No. 60/709,132, filed on Aug. 16, 2005.

(51) Int. Cl. G05B 19/418; G07G 1/00; G06F 9/46; G06F 17/30

(52) U.S. Cl. 705/10; 705/1; 705/8

(57) ABSTRACT

A service matching system for determining an optimized number of service providers for a given geographical region includes the determination of the allocation target that is proportional to the volume of services needed in the region. The need for additional service providers to service this demand is determined by the allocation target minus the existing number of service providers in the region. The price for participation in the service matching system is proportional to the volume of services needed.

### CROSS REFERENCE TO RELATED APPLICATIONS

This application claims priority to U.S. Provisional Patent Application No. 60/709,132, “Allocation Requirements and Methology” filed on Aug. 16, 2005 which is incorporated herein by reference for all purposes.

### BACKGROUND

Various Internet based computer systems have been developed for matching professional service providers with clients. These service matching systems typically allow potential clients to access a web site and post their service needs. These client posts generally include a basic description of the client's service needs. The service providers search through the client postings to determine if there are any desirable cases. The posts should provide enough information so that service providers can determine if they are qualified to provide the requested services and estimate the costs for performing the services. When a service provider finds a case of interest, they may contact the client with an offer for performing the services. If the client receives multiple offers, the client can select between the multiple service providers. The selected service provider can then perform the required services for the client for an agreed upon a price. After the services are performed, the client can post a review of the services received that is available to other clients. This can be helpful in deciding which service provider to select in the future. The service matching system makes money by charging the service providers a fee to use the system and access the client posts and typically does not charge the clients for their posts.

An example of such a service matching system used for lawyers is described in the pending U.S. patent application Ser. No. 09/876,390 which is assigned to LegalMatch and hereby incorporated by reference. In an embodiment of the LegalMatch system is used to match clients with attorneys. The client logs onto the LegalMatch web site and confidentially inputs the legal case needs through a series of web pages that describe the needed legal help. The web pages include case presentation questions that are designed by attorneys to guide the clients through the case disclosure process, as a lawyer would during an initial consultation. The appropriate LegalMatch member attorneys review the client's case.

Immediately after the case disclosure is finished, the case is processed by the LegalMatch system. E-mail notifications are sent to lawyers in the specific practice area and geographic location that the client selected. The cases are directed to the right lawyers even if the client lives in one location and needs legal help in another. In more urgent cases direct telephone calls are made to the LegalMatch Member Attorneys. The lawyers review the case information and identify the areas where the client needs legal help. The lawyers are not shown the client's identity until the client selects an attorney. Lawyers who are interested in the case individually respond to the client with personal messages detailing their relevant experiences and fee structures. The client reviews each lawyer's response message and can compare each lawyer's attorney profile to review his or her specific legal experience, practice areas, ratings, fees, and educational and professional affiliations. The client can then contact the lawyer or lawyers that the client feels will best help his or her case.

Because the service providers pay for the service matching system, they will want assurances that they will receive a fair share of the business that is posted on the web site while still giving the clients a choice between service providers. This requires the service matching system to provide proper ratios of service providers for a give number of client posts for each geographic region. If the service matching system covers the entire nation, there are metropolitan regions which have a large number of client posts and rural areas with much fewer client posts. If a region has too many service providers, there will be too few clients and too little business for the service providers. The service providers may find that the cost of the matching service is not a good value and discontinue using the service matching system. Alternatively, if there are too few service providers, the clients may not get enough service providers bidding on the posted work. If the clients do not receive a good response to their postings, they may also discontinue using the service matching system and they may look elsewhere for service providers. What is needed is a system that monitors and controls the ratio of service providers to service posts for each regional coverage area.

### SUMMARY OF THE INVENTION

The present invention is directed towards a method for determining the proper number of service providers for a given geographical region based upon various factors including service needs, region area and service activity. The present invention is also used to calculate the price of membership or allocation price for service providers to become members of the service matching system.

### BRIEF DESCRIPTION OF THE DRAWING

FIG. 1 is a block diagram of the matching system hardware components.

### DETAILED DESCRIPTION

The present invention is directed towards a method for determining the proper number of service providers for a given geographical region based upon various factors. The matching service system is in communications with the clients and service providers through a network such as an intranet or the internet. The matching system monitors all business activities between the service providers and the clients. The matching system determines the optimum number of service providers, i.e. the “allocation target” for all coverage regions based upon a multi factor algorithm. By knowing the optimum number of service providers for each region of the country, the service matching system can control the number of service providers in each region. The service provider can reject or allow applications from service providers based upon the allocation target of service providers in a geographic region.

Another use for the invention is to easily calculate the price of membership or allocation price for service providers to become members of the service matching system. This allocation price for the service provider is based upon the services being provided and the areas of coverage. For example, if the service matching system is for legal services, the services being provided would be different categories of the law: personal injury, intellectual property, tax, etc. A large law firm may be interested in using the matching service to obtain clients in many different categories of the law. In contrast, a specialist or a boutique firm may only want work one legal category. When a client posts a case, the case is identified by the legal category and transmitted to the member lawyers who work in this legal category. A multi-category member may receive more cases than a single category member and some categories may be more lucrative than others. Thus, the allocation prices may be greater for the multi-category service providers than the single category service provider. The inventive system includes an algorithm used to calculate the allocation price based upon the service category factor.

The allocation prices are also variable in terms of the regional coverage. The allocation cost for a larger region will be higher than the allocation costs for a small region. For example, if a service provider is in the San Francisco bay area, this area may be divided into North Bay, South Bay, East Bay and Central regions. The allocation price will depend upon the regional coverage areas covered. The service provider can select the regions of interest. A small law firm may only be interested in clients from one region while a larger law firm may be interested in obtaining client from the entire bay area and other areas as well. The region variable is another factor that the inventive system can use to determine the allocation price.

The inventive system uses a computer network to perform the desired allocation requirements functions on one or more computers each executing software instructions. The steps of controlling devices, accessing, downloading, and manipulating data, as well as other aspects of the present invention are implemented by a central processing unit (CPU) in computers which execute sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

According to one embodiment of the present invention, a server computer system transmits and receives data over a computer network or standard telephone line. Data may be loaded into the memory of the server computer from a storage device, or from one or more other computer systems over a network connection. For example, a consumer computer may transmit a sequence of instructions to the server computer in response to a message transmitted to the consumer over a network by the server. As the server receives the instructions over the network connection, the instructions are stored in the server's memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, or to any particular source for the instructions executed by the server or consumer computers.

FIG. 1 is a block diagram of the matching system hardware components. The network server 104 runs the matching system software and controls the attorney and consumer databases on mass storage devices. The network server 104 is connected to other computers 102 (consumer and attorney) via a network 110 which may be the Internet, a Wide Area Network (WAN), a Local Area Network (LAN), or any combination thereof. The computers are connected to the network through an information service provider 107. Various types of connections between the computers 102 and service providers 107 including: telephone wires (dial up modems, DSL), cable, wireless, T1, or any other type of connection.

In one embodiment of the present invention, the server computer 104 is a World-Wide Web (WWW) server that stores data in the form of ‘web pages’ and transmits these pages as Hypertext Markup Language (HTML) files over the Internet network 110 to one or more of the computers 102. The computers 102 typically run a “web browser” program to access the web pages served by server computer 104 that allows a user to access and view web pages provided by the web server 104. During a typical web browsing operation, a user on a computer 102 accesses a web page from the server computer 104 by typing or entering the URL corresponding to the server web site in the address field of his or her web browser.

In one embodiment of the present invention, wherein network 110 is the Internet, network server 104 also executes a web server process (not shown to avoid obscuring the illustration) to provide HTML (or XML or similarly coded) documents to client computers coupled to network 110. To access the HTML files provided by server 104, client computer 102 runs a web client process (typically a web browser, such as Netscape Navigator or Microsoft Explorer) that accesses and provides links to web pages available on server 104 and other Internet server sites. It should be noted that a network system 100 that implements an embodiment of the present invention may include a larger number of interconnected client and server computers than shown in FIG. 1.

As can be appreciated by those of ordinary skill in the art, the representative networked computers of FIG. 1, such as network server computer 104 can be implemented as any standard computer that includes a CPU coupled through a bus to other various devices. These devices could include random access memory (RAM), a read only memory (ROM), and mass storage devices (e.g., a magnetic disk, optical compact disk, or tape drive for storing data and instructions). The computer also typically includes input/output devices, such as, a display device, keyboard, and network interface device, along with other similar devices or interfaces. Any of the computers in FIG. 1 could be implemented in the form of personal computers, laptop computers, mainframe computers, or other type of workstation computers.

This specification discloses the reasons, methods and rules for everything pertaining to the allocation system. It is not meant to specify implementation details such as the look or flow of screens or details of the content on them. One of the most import pieces of this document is the definition of the terms we use as we describe the business rules. Understanding the exact meaning of the terms used is critical for understanding this specification. Even common terms such as county have a particular meaning that does not exactly match the common language definition.

One of the purposes of the requirements allocation reporting system is to create a system to report on our current allocations and identify where we need to add more lawyers to the system. The reporting system has two main requirements, production of a nightly report that identifies the top allocations that we need to sell in, and an application where individual allocations can be reported in real time and priced (referred to later in this document as the lookup application). There will also be certain back end data used by the system that must be administered.

Both the report and the individual lookup need to contain particular required data. The data is organized by allocations and for each allocation consists of; number of cases, the weighted number of attorneys, the number of pending attorneys, the sales need and the price. For reference, the number of attorneys and number of pending attorneys should be listed in total as well as being broken down by experience level. The number of cases should also be listed in total as well as being broken down by the requested experience level (including the number of cases where an experience level is not specified).

At the end of each business day, a nightly business report is prepared. The nightly report should contain the top 100 sales needs and the report should be automatically published to the network. It may also be useful to be able to report the top county/super category combinations so sales can more exactly pinpoint needs. The report should also contain a list of individual counties where the county's sales need is substantially higher or lower than the other counties in allocation region. This will help us identify when we may need to adjust allocation regions. The rules of what constitutes a disproportionate sales need still needs to be specified and should be editable.

Another feature of the present invention is the lookup application. In addition to our standard allocations the lookup application must also be able to define and display custom allocations. This means that it will be possible to both query either an allocation region or a customized set of counties and still get the complete set of data. It should also be able to display the basic data excluding a price for combinations of individual categories and counties for informational purposes. In all of these instances it should be possible to drill down into the actual list of cases with the number of offers made on each one from the number of cases displayed in the results.

The Administrative requirement application is used to administer the data that all this is derived from. The administrative application is able to define the various prices, ratios, regions, etc. that go into generating this data, and allows the user the ability to edit those definitions at will. The system is also used to perform routine maintenance so that the values the calculations in the system accurately reflect the real system usage. More details on the administration requirements appear below.

The system also calculates the sales needs. The primary purpose of this system is to figure out the sales needs, and so this is what drives most of the requirements. The formula for a sales need is very simple on the surface; a sales need is the allocation target, minus both the weighted number of attorneys and the number of pending attorneys. The details of each of these terms are a little more complicated.

The system calculates the allocation target. The allocation target is the number of cases multiplied by the allocation ratio and the result rounded down to the nearest whole number. For example if there are 200 cases and we chose an allocation ratio of 1 attorney for every 12 cases (or 0.0833) the allocation target is 200*0.0833, the result rounded down comes to 16 attorneys.

The system calculates the weighted number of attorneys. Each attorney is weighted by three factors login activity, offer activity, and county weights if the attorney has access to only part of the allocation region. This calculation is described below. The weighted number of attorneys is the sum of the individual attorney values for every attorney in the allocation. The login activity weight is calculated by comparing the number of days the attorney has logged on out of the last “X” days to a set of rules. For example the rules might look like this:
Logged in 10 or more days over the last “X” days, weight is 1
6 to 9 days, weight is 0.75
3 to 5 days, weight is 0.5
Less than 3 days, weight is 0.25

The rules for the login activity weight must be determined and entered into the system (including what the “X” number of days is), and there must be a way to edit the rules as they will likely be adjusted over time. There will be one global set of rules for this weight.

The offer activity weight is determined by first calculating the ratio of the number of offers made to the number of cases for the allocation. The number of offers meaning the offers made on the number of cases in the allocation, not the number of offers the attorney has made overall. The weight is the attorney's ratio divided by a target offer activity ratio with a maximum of 1. A different target offer activity ratio will be stored for every super category and must be editable as they will likely change over time.

For both the offer activity weight and the login activity weight if an attorney has been active for less than a given number of days the weights will be set to a predetermined number. The threshold number of days and the fixed weights must be entered into the system and be editable. There will be a single set of these values in the system.

If an attorney only has access to a portion of the allocation region then an additional county weights are used. A county weight is usually the ratio of the number of cases in a county the attorney can access to the total number of cases in the entire allocation region (though weights can be edited by manually). For each attorney the sum of the county weights for the counties in the allocation region he has access to is used.

The total value for an attorney is the product of these three weights. In other words the login activity weight multiplied by the offer activity weight multiplied by the sum of the county weights in the counties the attorney can access.

For example if the login activity weight is 0.75 and the offer activity weight is 0.5 and the attorney has access to counties that contain 65% of the cases of the whole region. That attorney's weighted value is 0.75*0.5*0.65, which is about 0.24, so this attorney would count as about one quarter of an allocated attorney (note that an attorney with such a low overall weight should be the exception and the login activity rules and target offer activity ratio should be set up so this is the case).

The system also obtains the number of pending attorneys. There needs to be integration between this system and the sales system so that we can obtain the number of attorneys that have recently been sold (or are far enough along in the sales process to be taken into account). Each pending attorney's value is equal to 1 if the attorney has access to the whole allocation region, otherwise equal to the sum of the county weights for the counties he has access to (as described above).

For example, if there is an allocation which has a number of cases equal to 300, and an allocation ratio of one attorney for every twenty cases (1/20 or 0.05) our allocation target is 300*0.05 which is 15. When the values are added up for all the attorneys the weighted number of attorneys comes out to 9, and there are three attorneys in this allocation recently so the number of pending attorneys is 3. The sales need is 15−9−3 which is equal to 3. Three attorneys would be seen in this allocation.

The inventive system may not have a fixed definition of geographic regions. Since most sales are on the basis of a certain radius from the zip code of the attorney's practice, the inventive system can create a region for each customer. For reporting purposes it benefits us to have a more manageable and identifiable set of regions, for this reason the inventive system may use a county based model for sales. Once the county based system is in place we will only be selling by county, however we must be able to work with existing sales. For this reason we define a county in the system as a collection of zip codes (which is essentially how the current system of radius from a given zip). This has a couple of major implications, zip codes do not always correspond to political boundaries like county lines and some counties are too large to be managed as a single sales area (Orange County for example). Since counties are just collections of zip codes; we can effectively split the actual counties up and define them as one or more counties in the system. It may not be too problematic if the county definitions extend past county lines, so zips that overlap into multiple counties will be listed in all the counties that contain them. The county definitions may be managed and occasionally edited. For this reason the administrative system should include a section modify all the county related data. The inventive system, can be modified to add the new county model as a basis for searching.

One of the most important functions of the system is automatically calculating the price of an allocation. A price is stored in the system for each combination of allocation region, super category and experience level. Prices in the system will be calculated using two stored values; a base price and a price multiplier (see definitions for details). Prices will be rounded up to the nearest $250 increment. Though all prices are initially calculated, individual prices are editable so they can be set manually for special cases. When a base price or price multiplier is changed, all prices dependent on the value must be updated. If prices that need to be recalculated have previously been changed manually the person making the change must be prompted to update the price if necessary, or revert it back to being automatically calculated. The administrative application must follow these rules when editing prices.

The prices for an actual sale is either the price in the database for that super category and allocation region, or if a custom allocation is defined for this sale the price is the sum of the price for each county, and the price for each county is the price for the allocation region it is contained within multiplied by the county weight. For example, say an attorney wants Family Law only in San Francisco County, but the allocation region includes Marin and San Mateo. The price for Family law in the San Francisco metropolitan region is $7,000. Based on case volume the county weight for San Francisco County is 60%. So the price we would charge is 7000*0.6 rounded up to the nearest $250 increment, yielding a result of $4,250.

In the inventive system, many values and rules have been defined that must be set and maintained. For this reason an administrative application must be created to maintain all the back end data used by this system. Here is a brief enumeration of the required administrative functionality.
1) An interface to administer county data that includes (see the section on the county model for more details):
   a) The ability to list counties and edit their definitions (the list of zips that makes up a county). A zip cannot be in the definition of more than one county so when saving a county definition, if a zip in the new definition exists in another county we need to handle it gracefully (i.e. possibly prompt to delete the zip for the other county).
   b) The county definition interface and allocation region interface must work together so that things are handled gracefully when a county definition is added or deleted (which may happen in the case of counties that are split up).
   c) If county definitions are changed we need to update the table that matches attorneys and cases for attorneys that access that county so the changes are reflected for existing cases on their homepages.
2) An interface to manage allocation regions:
   a) List super categories and the allocation regions under then and edit the list of counties within them. No county can appear in more than one allocation region (per super category) so that must be handled gracefully.
   b) The county weights for each county in an allocation region must also be editable here. There should be options to recalculate the weights, as well as manually edit them. When weights are calculated, counties that have too little data to calculate should be reported.
3) An interface to maintain prices which includes (see the section on pricing for more details):
   a) Editing base prices and price multipliers.
   b) When a base price or price multiplier is edited affected prices are recalculated and the user must be prompted to either update prices that have been set manually or revert them to being automatically calculated.
4) An interface to modify the weights and rules used in the sales need calculation including (see the section on calculating sales needs for details)
   a) Allocation ratios.
   b) The number of days to base the number of cases on.
   c) The number of days to base the county weights calculation.
   d) The number of days to base the login activity weight on.
   e) Rules for login activity weight. There should also be a way to see some statistics on login activity in this section.
   f) The offer activity targets for the offer activity weight. The system should calculate the ratios for each super category based on system usage and allow the user to edit the values.
   g) The minimum number of days and corresponding values for the offer activity and login activity weights.
5) Miscellaneous data.
   a) The rules that define what a disproportionate sales need is must be stored and edited (this is required for the nightly report).
   b) The rules for the minimum amount of data to calculate county weights.

There is also an ongoing requirement for maintaining the system. For the system to give the most accurate possible projections of our sales needs we will need to occasionally adjust some of the basic values and ratios to more accurately reflect accurate system usage. A minimum maintenance schedule should be created to update all the values in the administrative system. For example, if we achieve our goal to get attorneys to make more offers over time the target offer activity ratio would need to be adjusted to reflect this increased offer activity.

Definitions

Allocation—An allocation is an individual combination of a super category and an allocation region. For example, family law in the bay area would be one allocation, criminal law in north western Ohio another.

Allocation ratio—The allocation ratio is the ratio of the number of attorneys to the number of cases in a particular super category and a particular allocation region. For instance, if in Berkshire region we ideally want to have one active attorney on the system for each twenty personal injury cases; the allocation ratio for personal injury in the Berkshire region is 1/20 (or 0.05).

Allocation region—An allocation region is a basically a geographic area that is a subdivision of our market. The purpose of the allocation regions is so that we can define a manageable set of sales regions. Each region is represented by one or more counties. A set of regions will exist for each super category of law. Each county will only appear in a single region in each super category of law. For example, the allocation region named San Francisco Metropolitan area under Criminal Law might consist of the counties of San Francisco, San Mateo and Marin counties.

Allocation target—An allocation target is the target number of attorneys on the system in a particular allocation. The allocation target is based on the number of cases in a particular super category. To be exact the allocation target is the number of cases modified by an allocation ratio. For example, if in the Boston metropolitan area, based on current case load in Family law we need twelve attorneys; the allocation target for family law in Boston is 12. See the section on calculating the allocation target for details.

Base Price—The base price is used with the price multiplier to calculate the actual price of a sale. A base price is stored for every combination of super category and attorney experience level.

County—With some exceptions when we talk of a county we are actually taking of a particular county in the common definition. Our list of counties and their geographical area is taken essentially using US census data as the baseline. However some counties that are particularly large and/or populous can be split into several parts that we will still refer to as counties. Counties are defined internally as a set of zip codes. See the section on the county model for more information.

County weight—The county weight is the proportion of the number of cases in a single county of an allocation region compared to the total number of cases in the allocation. For example if an allocation region consists of San Francisco, Marin and San Mateo counties, and there are 500, 200, and 300 cases in each county respectively, San Mateo's county weight would be 0.3. The county weight is used when determining the weighted number of attorneys as well as determining prices. County weights are periodically calculated based on new cases received in the last 180 days, and can also be edited manually.

Custom allocation—A custom allocation is similar to a regular allocation except that it does not necessarily conform to a predefined allocation region. It still is defined by a single super category, but it may contain a customized set of counties and may cross the boundaries of existing allocation regions or even be a subset of an allocation region. For example, if a lawyer wants to have access to cases in only San Francisco and San Mateo, but the allocation region includes a larger area we will sell that lawyer a custom allocation.

Login Activity Weight—Login activity weight refers to a weight assigned to a particular attorney based on how often he logs in. It is calculated by averaging the number of times an attorney has logged into the system over a given period of days, and comparing that number to a table to determine the weight. See the section on calculating the weighted number of attorneys for details.

Number Of Cases—When we refer to the number of cases, it means the number of new cases posted in a particular allocation over a set period of days. The period is set within the system and can be edited.

Number Of Pending Attorneys—This is the number of attorneys that are not yet on the system but have reached a point in the sales process where we are relatively sure they will be up and running soon so we must consider them when we figure out our sales needs.

Offer Activity Weight—Offer activity weight is based on the ratio of number of cases to the number of offers an attorney has made on those cases. The actual weight is the attorney's ratio divided by a given target ratio with a maximum value of 1. See calculating the weighted number of attorneys for details.

Price Multiplier—A price multiplier is used in conjunction with a base price to determine the price of a sale. For each combination of super category and allocation region a price multiplier is stored. For example, is we want to charge twenty percent more for personal injury law in the New York metropolitan area the price multiplier stored for that super category and region is ‘1.2’.

Sales Need—A sales need is the number of attorneys that we need to sell in a particular allocation. In simple terms it is the allocation target minus the number of attorneys that are active (or soon to be active). See the section on calculating the sales need for details.

Super Category and Category—A super category is a general legal area of expertise. A category of law is a more specific area of law. There is a hierarchical relationship between the two; super categories contain one or more categories. Examples of super categories are: Criminal Law, Family Law. Criminal law for example might contain such categories as drunken driving, assault, etc. Categories and super categories are already defined in the LegalMatch system.

Target Offer Activity Ratio—For each super category we have a target ratio defined for the number of offers an attorney has made over the number of cases in an allocation. This is used to calculate the offer activity weight which is then used to calculate the weighted number of attorneys. This should reflect average offer activity on the system. See calculating the weighted number of attorneys for details.

Weighted Number Of Attorneys—The calculation to determine a sales need does not simply use the raw number of attorneys in the allocation's super category and allocation region. Each attorney is assigned a weight based on his activity on the system and how many counties in the region he has access to. See the section on calculating the weighted number of attorneys for details.

Details of a system for allocating service providers in a geographic region and valuing or pricing the allocations for a service matching system are described in more detail below. Although the present invention has been described in considerable detail with reference to specific exemplary embodiments, it will be evidence that various modifications and changes may be made to these embodiments without departing from the broader spirit and scope of the invention as set forth in the claims. For example, although the system has been described with reference to attorneys, it can similarly be used for other service professions such as doctors, home maintenance, car dealerships/repair, etc. Accordingly, the specification and drawings, which describe the service matching system are to be regarded in an illustrative rather than a restrictive sense.

What is claimed is:

1. A method for determining an optimized number of service providers in a service matching system for a given geographical region comprising the steps:
determining an allocation target based upon a case volume multiplied by an allocation ratio;
determining a sales need based upon the allocation target minus service providers in the region; and
determining a price of an allocation based upon the case volume.
